(19) United States
(12) Patent Application Publication
(10) Pub. No.: US 2001/0044896 A1
(43) Pub. Date: Nov. 22, 2001

(54) Authentication technique for electronic transactions

(76) Inventors: Gil Schwartz, Ramat Gan (IL); Guy Netef, Rishon Lezion (IL); Shay Granov, Modi'in (IL)

Correspondence Address: ABELMAN FRAYNE & SCHWAB, Attorneys at Law, 150 East 42nd Street, New York, NY, 10017, US

(21) Appl. No.: 09/799,264

(22) Filed: Mar. 5, 2001

Related U.S. Application Data
(60) Provisional application No. 60/187,353, filed on Mar. 6, 2000.

(51) Int. Cl. H04L 9/00

(52) U.S. Cl. 713/169

(57) ABSTRACT

A technique for authenticating a first party to a second party is applicable to electronic transactions. In addition to employing personal passwords, and a device operational parameter fingerprint, two signatures are employed, one being characteristic of the first party, and the other being associated with the computer or communications device of the first party. The signatures mutate at random intervals, responsive to mutation requests made by the device of first party to the device employed by the second party. The mutated signatures invalidate previous signatures, and are stored in the computing or communications devices of both parties. The mutation process authenticates the computer or communication device, and may also authenticate the password holder.

### CROSS-REFERENCE TO RELATED APPLICATIONS

This application claims the benefit of U.S. Provisional Application No. 60/187,353, filed Mar. 6, 2000.

### BACKGROUND OF THE INVENTION

1. Field of the Invention

This invention relates to the execution of electronic transactions. More particularly this invention relates to a technique of authenticating a participant in an electronic transaction to another participant via a data network.

2. Description of the Related Art

In copending application Ser. No. 09/737,148, filed Dec. 14, 2000, of common assignee herewith, and herein incorporated by reference, a computer implemented technique for facilitating secure electronic transactions anonymously is disclosed. In this technique a secure private agent establishes a client relationship with a customer, and mediates communication between the customer and electronic commerce sites over a data network, which can be the Internet. The secure private agent substitutes internally generated identifiers for personal details of the customer, completes details of the transaction on behalf of the customer, and authorizes payment. In some embodiments, the secure private agent even guarantees the credit of the customer to the electronic commerce site or a payment-processing agent. The secure private agent concurrently monitors Internet browsing activity of the customer and provides its services on demand, or automatically in background mode.

As some point, even in an anonymous transaction, it is necessary that an actual identity be properly associated with the customer so that settlement of the account can proceed. There is a risk of impersonation and fraud when conducting electronic transactions in general, and anonymous transactions in particular. Therefore, the acceptability of the technique disclosed in the above noted application Ser. No 09/737,148 and the utility of electronic commerce in general, would be enhanced if authentication of the customer could be made more reliable.

One prior art approach to accurate customer identification is the smart card, which requires possession of the card, and a user password, such as a personal identification number (PIN).

### SUMMARY OF THE INVENTION

It is therefore a primary object of some aspects of the present invention to improve the security of electronic commercial transactions.

It is another object of some aspects of the present invention to improve the reliability of the identification of a party to an electronic transaction.

These and other objects of the present invention are attained by a technique for authenticating a first party to a second party that is applicable to electronic transactions. In addition to employing personal passwords, and a device operational parameter fingerprint, two signatures are employed, one being characteristic of the first party, and the other being associated with the computer or communications device of the first party. The signatures mutate at random intervals, responsive to mutation requests made by the device of first party to the device employed by the second party. The mutated signatures invalidate previous signatures, and are stored in the computing or communications devices of both parties.

The invention provides a method for authenticating a device in an electronic transaction, which includes transmitting a device signature of a first device from the first device to a second device, verifying the device signature in the second device, mutating the device signature, and communicating the mutated device signature between the first device and the second device.

According to an additional aspect of the invention, the device signature is verified with reference to a primary device identifier that identifies the first device.

Yet another aspect of the invention includes transmitting a device configuration parameter fingerprint of the first device from the first device to the second device, and verifying the device configuration parameter fingerprint in the second device.

According to another aspect of the invention, the device configuration parameter fingerprint is encrypted.

Mutating the device signature is performed by either the first device or the second device.

Another aspect of the invention includes a delay for a random delay interval prior to beginning the transmission of the device signature.

According to a further aspect of the invention, mutating the device signature is accomplished by randomly varying a bit representation thereof.

According to yet another aspect of the invention, mutating the device signature is performed by communicating mutation transformation parameters, and transforming the device signature according to the mutation transformation parameters.

The invention provides a method for authenticating a device in an electronic transaction, which includes transmitting a device signature of a first device from the first device to a second device, transmitting a customer account signature from the first device to the second device, verifying the device signature in the second device, verifying the customer account signature in the second device, mutating the device signature, mutating the customer account signature, and communicating the mutated device signature and the mutated customer account signature between the first device and the second device.

According to an aspect of the invention, the step of verifying the device signature is performed with reference to a primary device identifier that identifies the first device, and the step of verifying the customer account signature is performed with reference to a username that identifies a user of the first device.

An additional aspect of the invention includes the further steps of transmitting a device configuration parameter fingerprint of the first device from the first device to the second Hidevice, and verifying the device configuration parameter fingerprint in the second device.

A further aspect of the invention includes transmitting a password of a user of the first device from the first device to the second device, and verifying the password in the second device. The device configuration parameter fingerprint may be encrypted.

Mutation of the device signature and the customer account signature may be performed by either the first device or the second device.

According to a further aspect of the invention, the step of mutating the device signature includes randomly varying a bit representation thereof.

According to an additional aspect of the invention, the step of mutating the customer account signature includes randomly varying a bit representation thereof.

According to yet another aspect of the invention, transmission of the device signature and the customer account signature from the first device to the second device is performed as a response to a challenge of the second device.

Still another aspect of the invention includes encrypting the customer account signature using a password of a user of the first device.

An additional aspect of the invention includes transmitting a password of a user of the first device from the first device to the second device, and verifying the password in the second device. The password may be an encrypted password.

According to still another aspect of the invention, the device signature and the customer account signature are mutated by communicating mutation transformation parameters, and applying a transformation that is based on the mutation transformation parameters to the device signature.

The invention provides a computer system for conducting electronic commerce, which includes a server, which has a software application executing therein, wherein the server is in communication with a user device via a data network. Program instructions of the software application are read by the server, causing the server, responsive to receipt of a device signature from the user device, to verify the device signature, mutate the device signature, and communicate the mutated device signature to the user device.

According to an aspect of the invention, the device signature is verified with reference to a primary device identifier that identifies the user device.

According to yet another aspect of the invention, the program instructions further cause the server to verify a device configuration parameter fingerprint responsive to receipt thereof from the user device. The device configuration parameter fingerprint may be encrypted.

According to an additional aspect of the invention, the device signature is mutated by randomly varying a bit representation thereof.

According to an aspect of the invention, the program instructions further cause the server, responsive to receipt of a customer account signature from the user device via the data network, to verify the customer account signature, mutate the customer account signature, and communicate the mutated customer account signature to the user device.

According to another aspect of the invention, the program instructions further cause the server to issue a challenge to the user device via the data network, wherein the device signature and the customer account signature are received by the server subsequent to issuing the challenge.

According to yet another aspect of the invention, the program instructions further cause the server, responsive to receipt of a password of a user of the user device, to verify the password. The password may be an encrypted password.

According to a further aspect of the invention, the program instructions further cause the server to encrypt the mutated customer account signature using a password of a user of the user device.

The invention provides a computer system for conducting electronic commerce, which includes a first server, connected to a user device via a data network, wherein the first server, transmits a device signature that identifies the user device on the data network. The first server operating in accordance with first program instructions, wherein the first server receives a device built-in identifier from the user device that is associated in the first server with the device signature. The system includes a second server, which has a software application executing therein, wherein the second server is in communication with the first server via the data network, and second program instructions of the software application are read by the second server, causing the second server, responsive to detection of the device signature, to verify the device signature, mutate the device signature, and communicate the mutated device signature to the first server.

According to a further aspect of the invention, a primary device identifier is further transmitted by the first server to the second server, and in verifying the device signature the second program instructions further cause the second server to associate the primary device identifier with a copy of the device signature stored therein.

According to an additional aspect of the invention, the first server transmits the device signature responsive to a control signal from the user device.

According to an aspect of the invention, the first server generates the device signature independently of the user device.

According to an aspect of the invention, the device signature is transmitted to the first server by the user device.

According to still another aspect of the invention, the request includes a device identification number of the user device, and the device signature is associated in the first server with the device identification number.

According to a further aspect of the invention, verifying the device signature is accomplished with reference to a primary device identifier that identifies the user device.

According to yet another aspect of the invention, the first program instructions cause the first server transmit a device configuration parameter fingerprint of the user device to the second server, and, responsive to receipt of the device configuration parameter fingerprint from the first server, the second program instructions further cause the second server verify the device configuration parameter fingerprint.

According to yet another aspect of the invention, the first server includes a random timer, and the first server transmits the device signature responsive to a signal from the random timer.

According to an aspect of the invention, the first program instructions cause the first server to transmit a customer account signature of the user device to the second server, and responsive to receipt of the customer account signature from the first server the second program instructions cause the second server to verify the customer account signature, mutate the customer account signature, and communicate the mutated customer account signature to the first server.

According to yet another aspect of the invention, the first program instructions cause the first server to transmit a username of a user of the user device to the second server, and the second program instructions cause the second server to associate the username with a copy of the customer account signature while verifying the customer account signature.

According to another aspect of the invention, the steps of transmitting the device signature and transmitting the customer account signature from the first server to the second server are performed as a response to a challenge of the second server that is issued to the first server via the data network.

According to a further aspect of the invention, the first program instructions cause the first server to encrypt the customer account signature using a password of a user of the user device. The password may be transmitted to the second server.

According to another aspect of the invention, the customer account signature is stored in the first server.

According to a further aspect of the invention, the customer account signature is stored in the user device.

According to an additional aspect of the invention, the device signature is stored in the first server.

According to an aspect of the invention, the device signature is stored in the user device.

The invention provides a computer software product for authentication of a participant in an electronic transaction, comprising a computer-readable medium in which computer program instructions are stored, which instructions, when read by a computer, cause the computer to receive a device signature of a device from a transmitter, verify the device signature, mutate the device signature, and communicate the mutated device signature to the transmitter.

According to an aspect of the invention, the step of verifying the device signature is performed with reference to a primary device identifier that identifies the device.

According to an aspect of the invention, the computer receives a device configuration parameter fingerprint of the device, and verifies the device configuration parameter fingerprint.

The invention provides a computer software product for authentication of a participant in an electronic transaction, comprising a computer-readable medium in which computer program instructions are stored, which instructions, when read by a computer, cause the computer to receive a device signature of a device from a transmitter, receive a customer account signature of the device from the transmitter, verify the device signature, verify the customer account signature, mutate the device signature, mutate the customer account signature, and communicate the mutated device signature and the mutated customer account signature to the transmitter.

According to yet another aspect of the invention, the device signature is verified with reference to a primary device identifier that identifies the device.

According to still another aspect of the invention, the computer further receives a device configuration parameter fingerprint of the device, and verifies the device configuration parameter fingerprint.

According to another aspect of the invention, the device signature and the customer account signature are received subsequent to a challenge issued to the transmitter.

According to a further aspect of the invention, the computer encrypts the customer account signature using a password of a user of the device.

According to yet another aspect of the invention, the computer receives a password of a user of the device from the transmitter, and verifies the password. The password may be an encrypted password.

According to another aspect of the invention, the computer receives a username of a user of the device from the transmitter, and the customer account signature is verified with reference to the username.

### BRIEF DESCRIPTION OF THE DRAWINGS

For a better understanding of these and other objects of the present invention, reference is made to the detailed description of the invention, by way of example, which is to be read in conjunction with the following drawings, wherein:

FIG. 1 is a high level block diagram of an arrangement for conducting electronic commerce;

FIG. 2 is a block diagram of a system in accordance with a preferred embodiment of the invention;

FIG. 3 is a flow diagram of a registration procedure, which is used in the operation of the system shown in FIG. 2;

FIG. 4 is a flow diagram of an authentication procedure, which is used in the operation of the system shown in FIG. 2;

FIG. 5 is a flow diagram of another authentication procedure, which is used in the operation of the system shown in FIG. 2;

FIG. 6 is a block diagram of a system in accordance with an alternate embodiment of the invention; and

FIG. 7 is a block diagram of a system in accordance with another alternate embodiment of the invention.

### DESCRIPTION OF THE PREFERRED EMBODIMENT

In the following description, numerous specific details are set forth in order to provide a thorough understanding of the present invention. It will be apparent however, to one skilled in the art that the present invention may be practiced without these specific details. In other instances well-known circuits, control logic, and the details of computer program instructions for conventional algorithms and processes have not been shown in detail in order not to unnecessarily obscure the present invention.

Software programming code, which embodies aspects of the present invention, is typically stored in permanent storage of some type, such as a computer readable medium. In a client/server environment, such software programming code may be stored on a client or a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

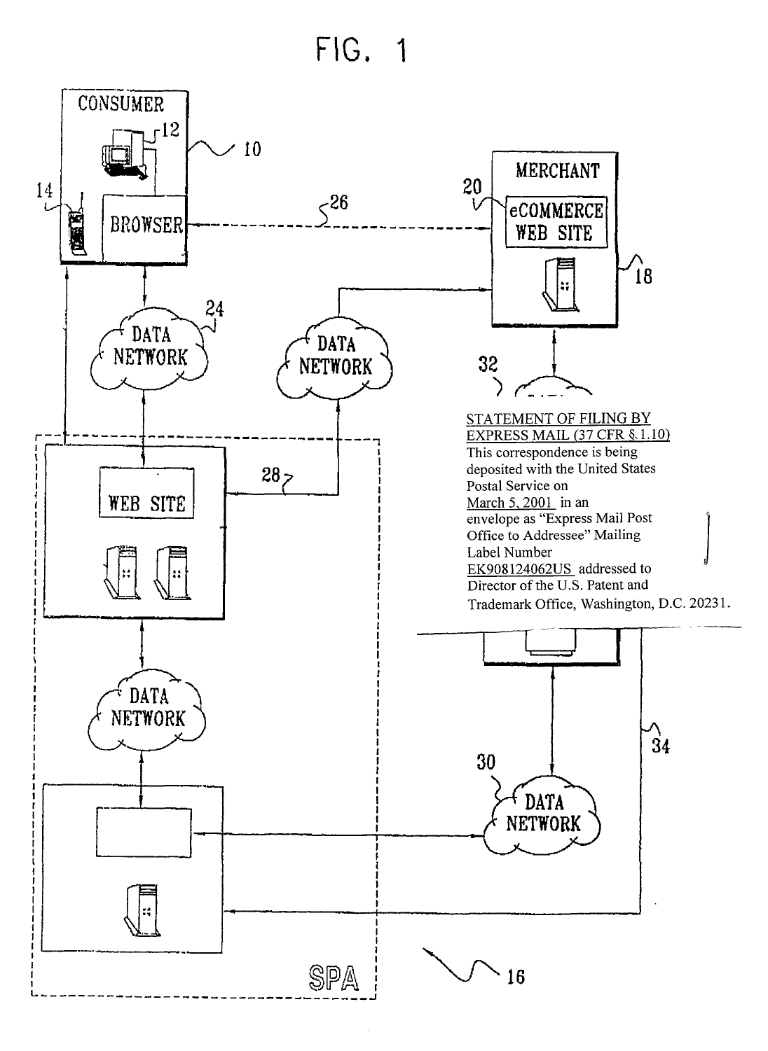

Turning now to the drawings, and in particular to FIG. 1 a high level view of an arrangement for conducting electronic commerce using the techniques of the present invention is shown. A customer 10 desiring to engage in electronic commerce is provided with a communication device 12, and optionally with a telephone device 14. The communication device 12 is preferably a personal computer equipped with a modem, but could be any suitably programmed wireless device, a personal digital assistant, or the like. The telephone device 14 can be a cellular telephone, a conventional telephone, or a networking device such as a net card associated with the personal computer, or a wireless device. Other parties to electronic commerce include a secure private agent 16, a merchant 18 having an electronic commerce site 20, and a credit card transaction processor 22.

The customer 10 normally communicates with elements of the secure private agent 16 via a data network, which can be the Internet, on a secure or insecure Internet channel 24. The secure private agent 16 is preferably the agent that is disclosed in further detail in the above noted application Ser. No. 09/737,148. Encryption of the network communications by known methods may be employed. The customer 10 and the merchant 18 communicate via the Internet on a channel 26. In some preferred embodiments of the invention the channels 24, 26 are wireless channels. During an electronic commerce transaction, a communication channel 28 may be established via the Internet between the secure private agent 16 and the merchant 18. An additional communication channel via a data network 30 may be established between the secure private agent 16 and the credit card transaction processor 22, preferably via a private network. In some embodiments, the secure private agent 16 can communicate directly with a private financial data network 32 over the channel 34.

Successful operation of the secure private agent 16 requires reliable authentication of the customer 10. The approach taken in a preferred embodiment of the invention employs a combination of information items, which includes information known or possessed by the customer 10, and an attribute of the customer 10. The information known or possessed by the customer 10 may be a password, or a correct answer to a challenge. The attribute of the customer 10 is a collection of characteristics of the communication device 12. The technique according to the invention is referred to herein as “Dual Electronic Signature Mutation Technology”.

In Dual Electronic Signature Mutation Technology signatures, sent by the customer 10 to the secure private agent 16, constitute the primary identification mechanism. While these signatures are similar in many respects to conventional “cookies” that are used by servers and browsers, they are not constant. Rather, as the name suggests, the signatures mutate from time to time, a process which invalidates previous signatures. Thus, even if a signature is stolen or discovered, it will only be effective for a limited time.

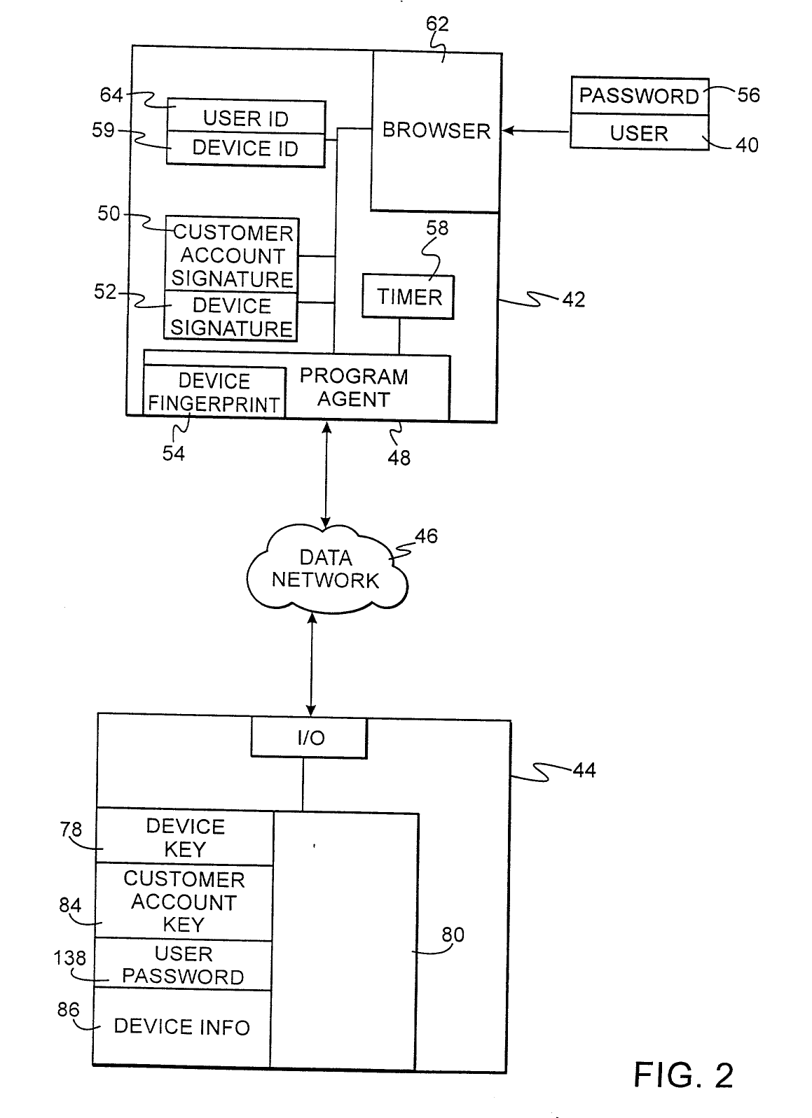

A preferred embodiment of the invention, employing the Dual Electronic Signature Mutation Technology is explained with reference to FIG. 2. While this embodiment is explained with reference to a computer, other devices, such as wireless devices, can function in the role of the computer.

A user 40 operates a computer 42 in order to engage in an electronic transaction. The computer 42 is in communication with a server 44 via a data network 46. The server 44 is a component of the secure private agent 16 (FIG. 1).

A program 48 executing in the computer 42 maintains files containing the customer account signature 50 and the device signature 52. The program 48 also dynamically collects and computes a device configuration parameter fingerprint 54. A password 56 set by the user 40 in a conventional manner is used to protect the file containing the customer account signature 50, using encryption. The device signature 52 is protected using an encryption key known to the program 48. In an alternative embodiment the customer account signature 50 is also protected using an encryption key known to the program 48 and the files can be combined into a single file. In such an embodiment the user password 56 is not used to restore the customer account signature 50 from a file, but is instead sent in some messages to the server 44 for authentication.

The customer account signature 50 is a 64-bit number, which is generated by the server 44, and is assigned to the user 40 using the device 42. The device signature 52 is also a 64-bit number, which is generated by the server 44. The device configuration parameter fingerprint 54 is a 256-bit number, which is descriptive of the computer 42, and is base on information such as processor type, operating system version, memory configuration, I/O devices, software configuration, and the like. By including a sufficient number of parameters, a key can be developed that is distinctive, even in environments in which many similar computers are purchased in bulk quantities for use by the workforce. Central processing unit (CPU) signatures, where available, may also be included in the device configuration parameter fingerprint 54.

A random timer 58 is used to time events associated with the program 48. The random timer 58 can be implemented as a computer process or be realized in hardware. Additionally, user actions and system generated messages can also trigger events associated with the program 48.

In some embodiments, another identifier, the primary device identifier 59 (MachineID), may also be stored in the computer 42. This identifier identifies the device in the same manner that a userid or username identifies a user, i.e. it is unique to the particular' computer 42. This identifier can assist optimization of device signature verification.

### Registration Procedure

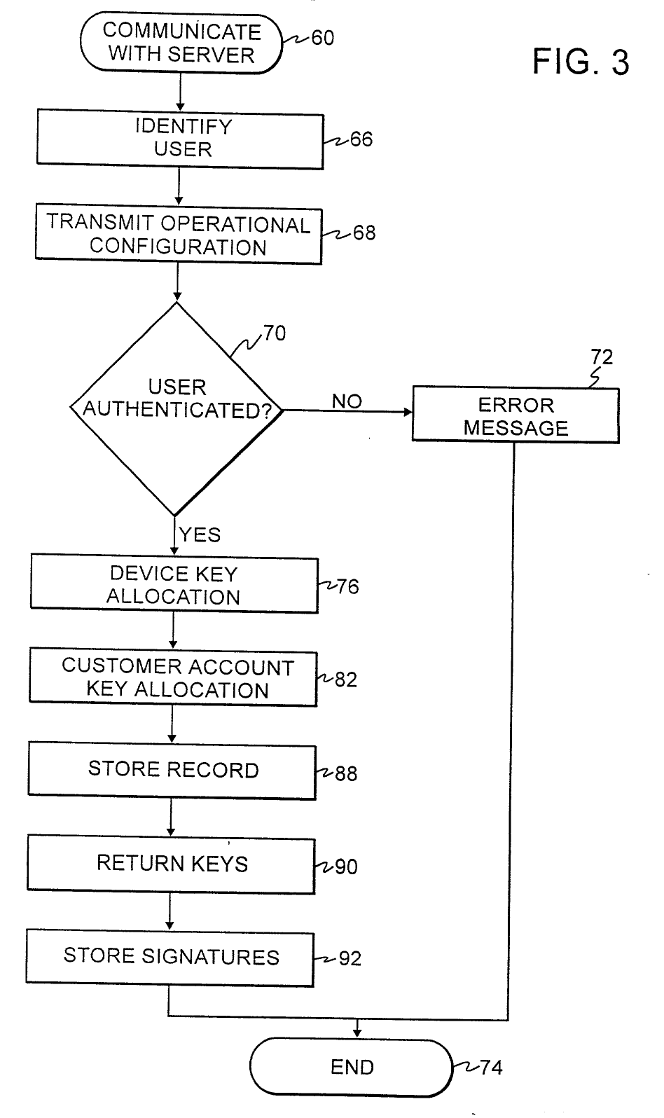

The customer account signature 50 and the device signature 52 are allocated by the server 44. A registration procedure in which the customer account signature 50 is initially produced is explained with reference to FIGS. 2 and 3. At initial step 60, secure communication is established between the computer 42 and the server 44 over the data network 46, or optionally over a secure private channel. This is done using conventional program facilities such as HTTPS messages through a browser 62. The user 40 identifies himself to the server 44 using a username 64 and password 56 at step 66. In alternative embodiments, the user may further identify himself using a one time assigned secret or a challenge. The program 48 also transmits the current device configuration parameter fingerprint 54 of the computer 42 to the server 44 at step 68.

At decision step 70, the server 44 authenticates the user based on the identification information sent by the program 48 and data that it has preloaded in its database. The preloaded data in server 44 database is populated outside of the currently described process by the server owner, which is interested in strong authentication of the user. If the test at decision step 70 indicates failure in authentication of the user, then an error message is sent by the server 44 to the program 48 at step 72, and control then proceeds to termination step 74. Otherwise, at step 76, the server 44 allocates a device key 78, which is a 64-bit binary number, and memorizes it in a database 80. At step 82, the server 44 allocates a customer account key 84, which is a 64-bit binary number, and memorizes it in the database 80. The device configuration parameter fingerprint 54 is memorized by the server 44 in the device information record 86 at step 88. At step 90, the device key 78 and the customer account key 84 are returned to the computer 42, and at termination step 92, the program 48 stores the customer account key 84 as the customer account signature 50, and stores the device key 78 as the device signature 52. In some embodiments, at step 76, the server 44 determine an index value for quick search of the device key 78, and in step 90 returns it to computer 42, to be stored as the primary device identifier 59.

### Random Mutation Request

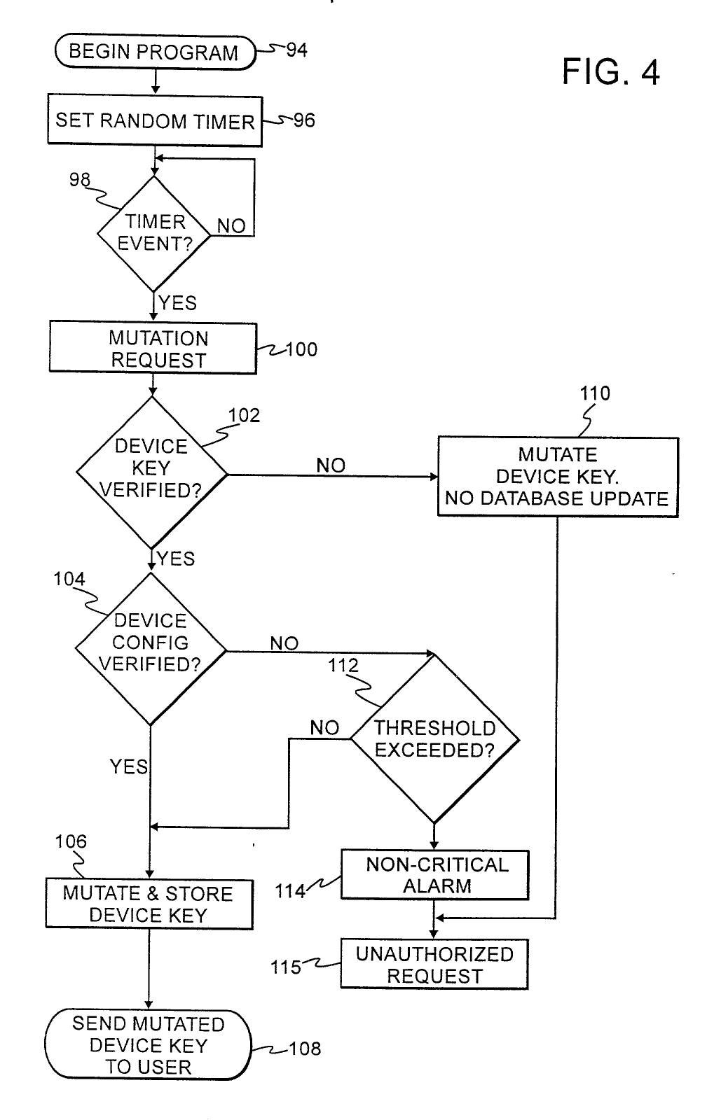

Further details of the technique are disclosed with reference to FIGS. 2 and 4. The program 48 begins to execute in the computer 42 at initial step 94. The random timer 58 is set at step 96 to trigger at random intervals, which have system defined lower and upper limits. Practical limits for the random intervals have been found to be 30 and 120 minutes respectively. In another embodiment of the invention, a system event or a user driven event sets the trigger.

At step 98, there is a delay until the random timer 58 triggers. Then, at step 100 the program 48 transmits a mutation request to the server 44, which includes the current device signature 52 and the device configuration parameter fingerprint 54. The primary device identifier 59 is also transmitted in the presently preferred embodiment. It is used by the server 44 as an index to locate the device key 78. In some embodiments, the device configuration parameter fingerprint 54 may be omitted. At decision step 102 the server 44 determines whether the device signature 52 that is contained in the mutation request conforms to the device key 78 that is currently stored in the database 80.

If the test at decision step 102 indicates agreement, then the computer 42 or other user device is tentatively identified at the server 44. Next at decision step 104 it is determined whether the device configuration parameter fingerprint 54 is in agreement with the device information record 86. The intent of this determination is to obtain assurance that the mutation request originates from the particular device that is known to hold the device signature 52.

If the test at decision step 104 indicates agreement, then control proceeds to step 106, where the server 44 updates the device key 78, and stores it in the database 80. In the currently preferred embodiment of the invention, the device key 78 is mutated randomly in step 106. At final step 108 the new device key 78 is returned to the computer 42, where the program 48 updates the device signature 52, using the updated device key 78, which it has just received from the server 44. In another embodiment, the server 44 sends only mutation information, such as transformation parameters to the computer 42, which computes the new device signature 52 using the mutation information, for example, by applying the parameters to transform the old device signature into a mutated device signature.

If at decision step 102 there is a lack of agreement between the device signature 52 and the device key 78, then it is assumed that a fraudulent agent has initiated the mutation request.

In some embodiments, at step 110, a false update of the device key 78 is generated. However, the database 80 is not updated. Control then proceeds to step 115, where an unauthorized request is recognized. In step 110, the server responds by issuing a false indication of acceptance, so as not to alert the requester that his unauthorized request has been detected.

In other embodiments step 110 is not performed and control proceeds directly from decision step 102 to step 115. At step 115 of such embodiments, the server 44 either does not respond at all, or responds by generating an error message.

If at decision step 104 there is a lack of agreement between the device configuration parameter fingerprint 54 and the device information record 86, a test is made at decision step 112 to determine whether the disagreement exceeds a critical threshold, which is determined according to a control policy that in some embodiments is set by the customer, and in other embodiments is a policy of the secure private agent 16 (FIG. 1). In many environments, the configuration of the computer 42 may change frequently in minor respects. For example, the computer's memory could be increased, or new hardware added. It is optional to allow such variations without rejecting the mutation request.

If the critical threshold is not exceeded at decision step 112, then control proceeds to step 106 as if there were a complete match. However, if the critical threshold is exceeded, then at step 114 a non-critical alarm status is established. This indicates an unconfirmed change in the configuration parameters of the computer 42, which could be fraudulent. In such case, some user services are permitted, while others may be blocked until confirmation from the user 40 is obtained. Depending on the policy in force, control may proceed to step 106. However, in the presently preferred embodiment control proceeds to step 115, where an unauthorized request is recognized.

### Challenged Mutation Request

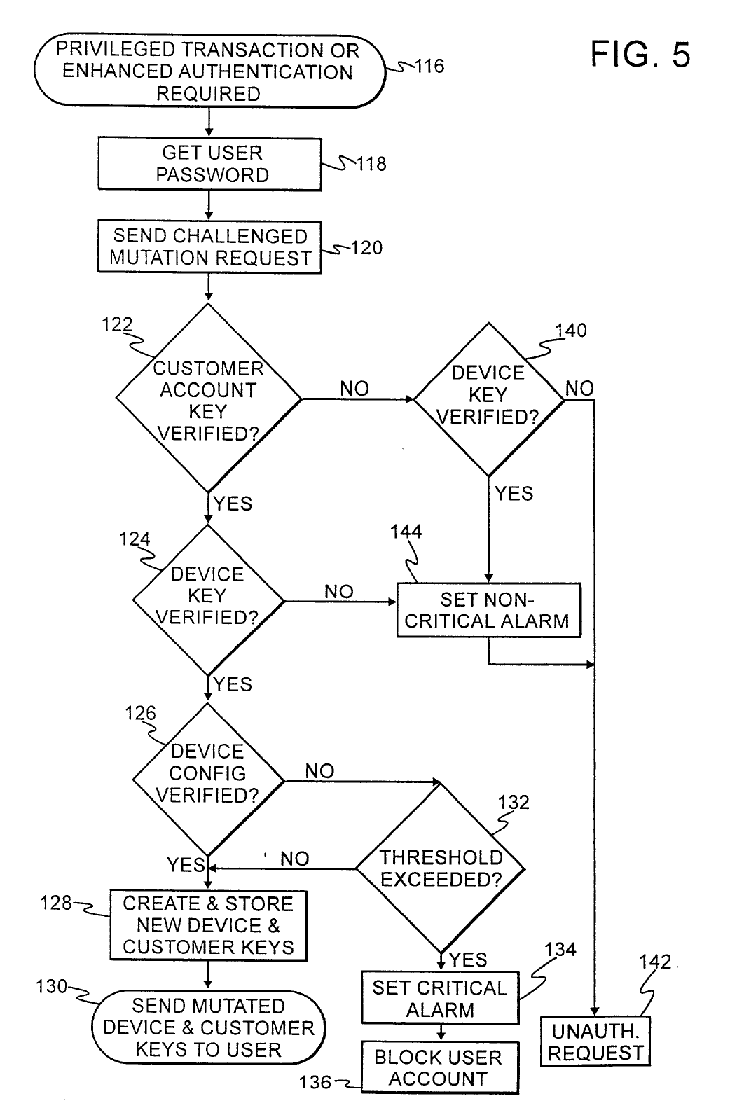

A variant mutation request is now disclosed with reference to FIGS. 2 and 5. At initial step 116, the user 40 desires a specific service from the server 44, where a high degree of authentication is required, or attempts to perform a privileged transaction therewith. In order to achieve a higher degree of authentication, a procedure involving a variant mutation request, referred to herein as a “challenged mutation request”, is executed. The user 40 is prompted for a password by the program 48 at step 118. At step 120, the program 48 initiates a challenged mutation request to the server 44. The challenged mutation request includes the current customer account signature 50, the device signature 52, and the device configuration parameter fingerprint 54. In those embodiments where the customer account signature 50 is not encrypted using the password 56, but instead is encrypted using an encryption key known to the program 48, the password 56 is also included in the challenged mutation request. In some embodiments, the device configuration parameter fingerprint 54 may be omitted. At decision step 122 the customer account signature 50 is compared at the server 44 with the customer account key 84. If the challenged mutation request also included the password 56, than the password 56 is also tested by the server 44 at step 122 to make sure there is full agreement of the customer account signature 50 and the password 56 with the corresponding values stored in server 44 database 80.

If the comparison at decision step 122 indicates a match, then control proceeds to decision step 124. At decision step 124 the server 44 determines whether the device signature 52 that is contained in the mutation request conforms to the device key 78 that is currently stored in the database 80.

If the test at decision step 124 indicates agreement, then the customer and his account are tentatively identified at the server 44. Next at decision step 126 another determination is made to determine if the device configuration parameter fingerprint 54 is in agreement with the device information record 86. The intent of this determination is to obtain assurance that the mutation request originates from the particular device that is known to hold the customer account signature 50. If the test at decision step 126 indicates agreement, then control proceeds to step 128, where the server 44 updates the customer account key 84 and the device key 78. Both of these updated keys are stored in the database 80. At final step 130 the new customer account key 84 and the new device key 78 are returned to the computer 42, where the program 48 updates the customer account signature 50, using the updated customer account key 84 and updates the device signature 52, using the device key 78, which have just been received from the server 44.

If at decision step 126 there is a lack of agreement between the device configuration parameter fingerprint 54 and the device information record 86, a test is made at decision step 132 to determine whether the disagreement exceeds a critical threshold, which is determined according to a control policy that in some embodiments is set by the customer, and in other embodiments is a policy of the secure private agent 16 (FIG. 1). This may be the same or a different control policy than the control policy described in the discussion of decision step 112 (FIG. 4).

If the critical threshold is not exceeded at decision step 132, then control proceeds to step 106 as if there were a complete match. However, if the critical threshold is exceeded, then at step 134 a critical alarm status is established. This indicates a need to immediately contact the user, as the likelihood of attempted fraud is high. The perpetrator is believed to have exposed the customer account signature 50 and the device signature 52, potentially the password 56 has itself been compromised. At step 136, a message is sent from the server 44 to the computer 42 indicating that the account of the user 40 has been temporarily blocked. The basis for setting a critical alarm rather than a non-critical alarm in step 134, is the assumption that the device configuration parameter fingerprint 54 is unlikely to change precisely at the time a privileged action is being undertaken at step 116. Normally changes in the device configuration parameter fingerprint 54 are tracked during random mutation requests, which occur much more commonly.

However, in those embodiments where the challenged mutation request lacks the device configuration parameter fingerprint 54, decision step 126 is not performed, and steps 138, 134, and 136 are also omitted. In such embodiments control proceeds directly from decision step 124 to step 128.

If at decision step 122 there is lack of agreement, then control proceeds to decision step 140. At decision step 140 the server 44 determines whether the device signature 52 that is contained in the challenged mutation request conforms to the device key 78 that is currently stored in the database 80.

If at decision step 140 there is lack of agreement, then neither of the customer account signature 50 nor the device signature 52 could be validated, and at step 142 the server 44 responds by issuing a message to the computer 42 that an unauthorized request has been received. The requested service is denied. However, the account remains open for future service requests. This situation could arise as the result of an early attempt to commit fraud. It could also arise if a fraudulent transaction had occurred earlier, and now the legitimate user is attempting to perform a privileged transaction in his account. In the latter case the user 40 could block the account using his own password, or by contacting the organizational support of the secure private agent 16 (FIG. 1).

If at decision step 124 there is a lack of agreement between the keys being compared, or the test for a match was successful at decision step 140, then control proceeds to step 144. Entry into step 144 indicates that there has been a failure to validate one of the customer account signature 50 and the device signature 52, but the other signature was validated. This situation characterizes either an early fraud attempt or corruption of data at the computer 42. At step 144 a non-critical alarm status is established, and control proceeds to step 142.

### EXAMPLE

Listings 1-4 illustrate actual message traffic between a customer device and a server. Table 1 explains the terms used in these listings.

TABLE 1

| Name | Type | Remarks |
|---|---|---|
| MachineKey | Integer | Number of current and mutated |
| NewMachineKey | | authentication keys, which are as- |
| | | signed to the machine running the |
| | | Agent. |
| CustomerKey | Integer | Number of current and mutated |
| NewCustomer- | | authentication keys, which are as- |
| Key | | signed to the customer using the |
| | | machine running the Agent. |
| MachineId | Integer | A unique sequence number assigned |
| | | to the Agent running on this |
| | | machine by the Server. |
| CustomerId | Integer | A unique sequence number assigned |
| | | to the customer. The same sequence |
| | | number is used by all agents serv- |
| | | ing the customer. |
| Action | String | The action requested by the Client |
| | | using this message. |
| Machine- | Integer | Device configuration parameter finger- |
| Properties | | print |

The data transmitted in a mutation request is shown in Listings 1 and 2. Header information has been omitted for clarity.

Listing 1
;Message from program to server
Action=Mutation Request
MachineId=0398210000006537
MachineKey=797e987987f897b2
MachineProperties=
e22eda33c430781d3937712f8e2236548a0c324f4935510e
Listing 2
;Response from server to program
Action=Mutation Response
MachineId=0398210000006537
NewMachineKey=4568e3165e843214

Listing 3 and Listing 4 are data transmitted in a challenged mutation request.

Listing 3
;Message from program to server
Action=Challenged Mutation Request
MachineId=0398210000006537
CustomerId=3322310000000216
MachineKey=4568e3165e843214
CustomerKey=9889654e54e48644
MachinePropeties=
e22eda33c430781d3937712f8e2236548a00324f4935510e
Password=F4404A5B861DA3B2884542A7C081515EB48D38B3
Listing 4
;Response from server to program
Action=Challenged Mutation Response
MachineId=0398210000006537
CustomerId=3322310000000216
NewMachineKey=486c5446e654b648
NewCustomerKey=867a979131c8684e

### Alternate Embodiments

Referring again to FIG. 2, in some embodiments, the computer 42 may be a portable or wireless device, for example a cellular telephone, or personal digital assistant. Such portable devices may lack the capability of file storage in a conventional computer-readable medium, such as a disk drive, or removable media. The customer account signature 50 and the device signature 52, an encrypted password 56, and a device configuration parameter fingerprint 54 may be stored in flash memory, or in a battery-powered RAM.

In other embodiments, the customer account signature 50, the device signature 52, the encrypted password 56, and the device configuration parameter fingerprint 54, may be further encrypted using encryption techniques known to the art, including techniques such as shuffling or winnowing the data to scramble it.

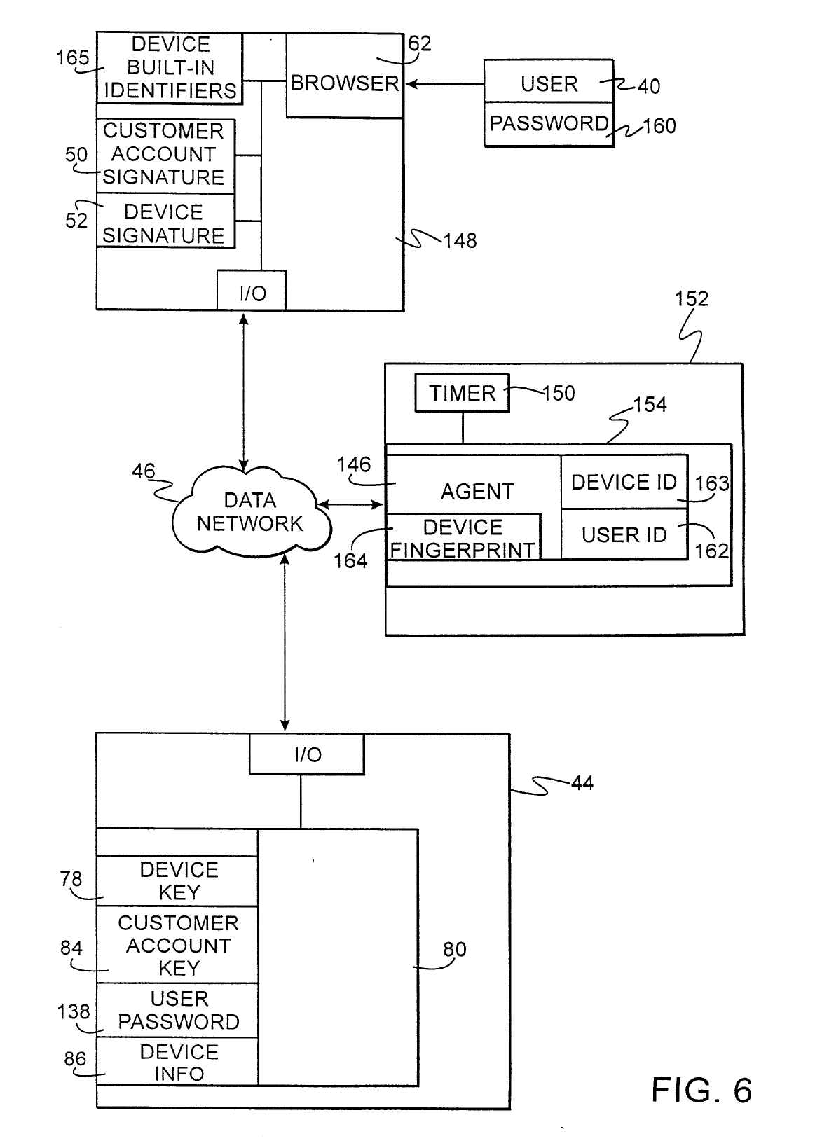

Referring now to FIG. 6 yet another alternate embodiment is shown, which is similar to the first embodiment, except now the program 48 has been replaced by a remote agent 146 which interacts with a customer device 148 via the data network 46. In this embodiment the customer device 148 is typically a personal computer, but could be another device having sufficient capabilities to store information including the customer account signature 50 and the device signature 52. The customer device 148 may include the browser 62. A random timer 150 associated with the agent 146 operates in the same manner as the random timer 58 of the first embodiment. The agent 146 may run on a server 152 employing the wireless application protocol (WAP). The agent 146 stores the username 162 of the user 40 and the primary device identifier 163. The username 162 is used by the server 44 as an index to locate the customer account key 84, and the primary device identifier 163 is similarly used by the server 44 to access the device key 78 as in the previous embodiment. The agent 146 can take advantage of the device built-in identifiers 165 that are available in the WAP environment and use them as a basis for constructing the device configuration parameter fingerprint 164. When the user 40 desires a service that requires authentication, a request sent from the customer device 148 is intercepted by or routed via the agent 146. This request includes the device signature 52 from the customer device 148, an example of which is a browser cookie, and the device configuration parameter fingerprint 164. If the request is a challenged mutation request, it also includes the customer account signature 50 from the customer device 148, and in some embodiments the user password 160. In subsequent steps of the authentication process the agent 146 plays the role of the program 48 (FIG. 2), and communications are exchanged between the server 152 and the server 44 in the same manner as are exchanged between the computer 42 (FIG. 2) and the server 44 of the first embodiment. Upon completion of a mutation request the mutated versions of the customer account signature 50 and the device signature 52 are sent from the agent 146 to the customer device 148 which replace old versions thereof.

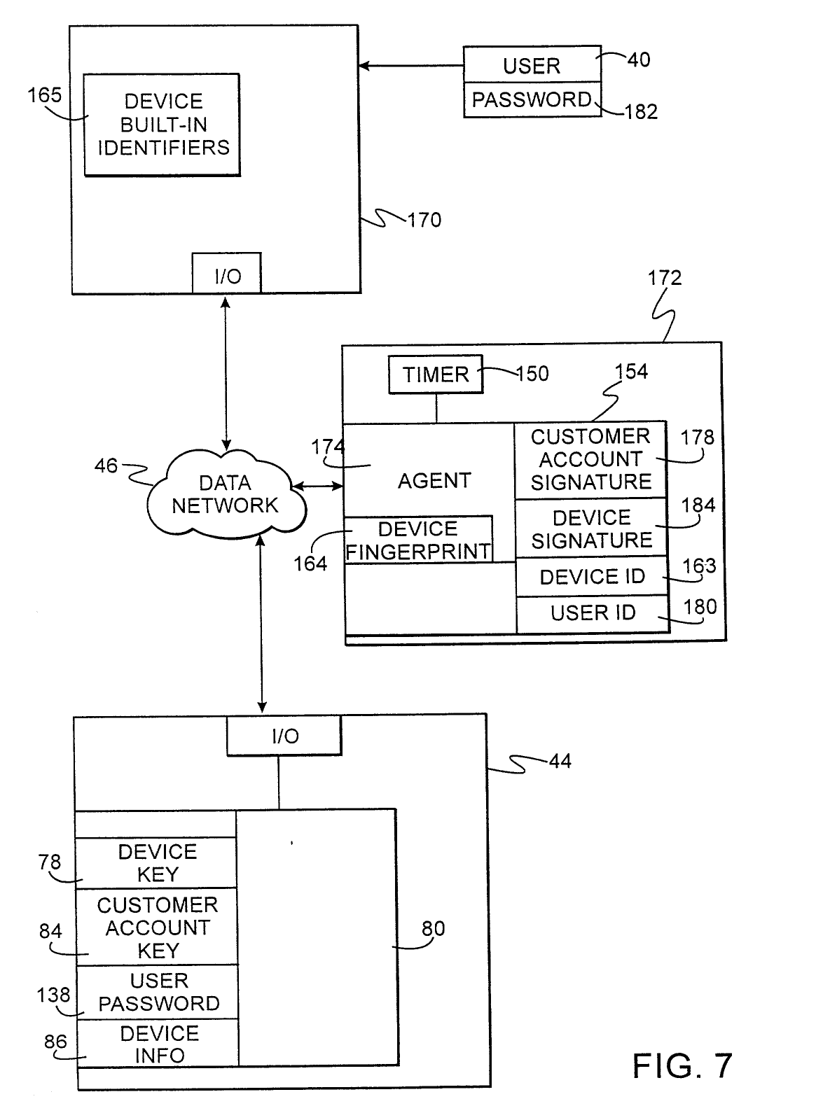

FIG. 7 illustrates still another alternate embodiment of the invention, which is similar to the embodiment shown in FIG. 6. However, the customer device 170 is much more limited in its capabilities. The customer device 170 could be, for example, a cellular telephone, or a minimal version of a personal digital assistant, or another wireless device. It does not have the capabilities of maintaining either a customer account signature or a device signature, but it does have the ability to request services from the server 44, and therefore may require authentication. When a request for services is initiated, it is intercepted by or routed via a server 172 hosting an agent 174. The agent 174 is similar to the agent 146 (FIG. 6). The agent 174 maintains information concerning the user 40, which may include one or more of a customer account signature 178 and a username 180. The agent 174 also maintains the device signature 184 for the customer device 170. When required, the agent 174 computes a device configuration parameter fingerprint 164 based on the device built-in identifiers 165. In subsequent steps of the authentication process the agent 174 plays the role of the program 48 (FIG. 2), and communications are exchanged between the server 172 and the server 44 in the same manner as are exchanged between the computer 42 (FIG. 2) and the server 44 of the first embodiment. Upon completion of a mutation request, the mutated versions of the customer account signature 178 and the device signature 184 are stored in the server 172. It should be noted that requests generated from the customer device 170 include the device configuration parameter fingerprint 164, and in some embodiments the user password 182. In embodiments in which requests are independently initiated by the server 172, this information is not included.

While this invention has been explained with reference to the structure disclosed herein, it is not confined to the details set forth, and this application is intended to cover any modifications and changes as may come within the scope of the following claims:

What is claimed is:

1. A method for authenticating a device in an electronic transaction, comprising the steps of:
transmitting a device signature of a first device from said first device to a second device;
verifying said device signature in said second device;
mutating said device signature to define a mutated device signature; and
communicating said mutated device signature between said first device and said second device.

2. The method according to claim 1, further comprising the step of transmitting a primary device identifier that identifies said first device, wherein said step of verifying said device signature is performed with reference to said primary device identifier.

3. The method according to claim 1, further comprising the steps of:
transmitting a device configuration parameter fingerprint of said first device from said first device to said second device; and
verifying said device configuration parameter fingerprint in said second device.

4. The method according to claim 3, wherein said device configuration parameter fingerprint is encrypted.

5. The method according to claim 1, wherein said step of mutating said device signature is performed by said second device.

6. The method according to claim 1, wherein said step of mutating said device signature is performed by said first device.

7. The method according to claim 1, further comprising the step of:
delaying for a random delay interval prior to performing said step of transmitting.

8. The method according to claim 1, wherein said step of mutating said device signature comprises randomly varying a bit representation thereof.

9. The method according to claim 1, wherein said step of mutating said device signature is performed by communicating mutation transformation parameters; and
applying a transformation according to said mutation transformation parameters to said device signature.

10. A method for authenticating a device in an electronic transaction, comprising the steps of:
transmitting a device signature of a first device from said first device to a second device;
transmitting a customer account signature from said first device to said second device;
verifying said device signature in said second device;
verifying said customer account signature in said second device;
mutating said device signature to define a mutated device signature;
mutating said customer account signature to define a mutated customer account signature; and
communicating said mutated device signature and said mutated customer account signature between said first device and said second device.

11. The method according to claim 10, further comprising the steps of:
transmitting a primary device identifier that identifies said first device, wherein said step of verifying said device signature is performed with reference to said primary device identifier; and
transmitting a username of a user of said first device, wherein said step of verifying said customer account signature is performed with reference to said username.

12. The method according to claim 10, further comprising the steps of:
transmitting a device configuration parameter fingerprint of said first device from said first device to said second device; and
verifying said device configuration parameter fingerprint in said second device.

13. The method according to claim 12, further comprising the steps of:
transmitting a password of a user of said first device from said first device to said second device; and
verifying said password in said second device.

14. The method according to claim 12, wherein said device configuration parameter fingerprint is encrypted.

15. The method according to claim 10, wherein said steps of mutating said device signature and mutating said customer account signature are performed by said second device.

16. The method according to claim 10, wherein said steps of mutating said device signature and mutating said customer account signature are performed by said first device.

17. The method according to claim 10, wherein said step of mutating said device signature comprises randomly varying a bit representation thereof.

18. The method according to claim 10, wherein said step of mutating said customer account signature comprises randomly varying a bit representation thereof.

19. The method according to claim 10, wherein said steps of transmitting said device signature and transmitting said customer account signature from said first device to said second device are performed as a response to a challenge of said second device.

20. The method according to claim 10, further comprising the step of encrypting said customer account signature using a password of a user of said first device.

21. The method according to claim 10, further comprising the steps of:
transmitting a password of a user of said first device from said first device to said second device; and
verifying said password in said second device.

22. The method according to claim 21, wherein said password is an encrypted password.

23. The method according to claim 10, wherein said step of mutating said device signature is performed by communicating mutation transformation parameters; and
applying a transformation according to said mutation transformation parameters to said device signature.

24. The method according to claim 10, wherein said step of mutating said customer account signature is performed by communicating mutation transformation parameters; and
applying a transformation according to said mutation transformation parameters to said customer account signature.

25. A computer system for conducting electronic commerce, comprising:
a server, having a software application executing therein, wherein said server is in communication with a user device via a data network, and program instructions of said software application are read by said server, causing said server to perform the steps of:
responsive to receipt of a device signature from said user device, verifying said device signature;
mutating said device signature to define a mutated device signature; and
communicating said mutated device signature to said user device.

26. The system according to claim 25, wherein said step of verifying said device signature is performed with reference to a primary device identifier that identifies said user device.

27. The system according to claim 25, wherein said program instructions further cause said server to further perform the steps of:
responsive to receipt of a device configuration parameter fingerprint from said user device, verifying said device configuration parameter fingerprint.

28. The system according to claim 27, wherein said device configuration parameter fingerprint is encrypted.

29. The system according to claim 25, wherein said step of mutating said device signature comprises randomly varying a bit representation thereof.

30. The system according to claim 25, wherein said program instructions further cause said server to further perform the steps of:
responsive to receipt of a customer account signature from said user device via said data network, verifying said customer account signature;
mutating said customer account signature to define a mutated customer account signature; and
communicating said mutated customer account signature to said user device.

31. The system according to claim 30, wherein said program instructions further cause said server to further perform the step of:
issuing a challenge to said user device via said data network, wherein said device signature and said customer account signature are received by said server subsequent to performing said step of issuing said challenge.

32. The system according to claim 31, wherein said program instructions further cause said server to perform the steps of:
responsive to receipt of a password of a user of said user device, verifying said password.

33. The method according to claim 32, wherein said password is an encrypted password.

34. The system according to claim 30, wherein said program instructions further cause said server to perform the step of:
encrypting said mutated customer account signature using a password of a user of said user device.

35. A computer system for conducting electronic commerce, comprising:
a first server, connected to a user device via a data network, wherein said first server transmits a device signature that identifies said user device on said data network, said first server operating in accordance with first program instructions, wherein said first server receives a device built-in identifier from said user device that is associated in said first server with said device signature;
a second server, having a software application executing therein, wherein said second server is in communication with said first server via said data network, and second program instructions of said software application are read by said second server, causing said second server to perform the steps of:
responsive to detection of said device signature, verifying said device signature;
mutating said device signature to define a mutated device signature; and
communicating said mutated device signature to said first server.

36. The system according to claim 35, wherein a primary device identifier that identifies said user device is further transmitted by said first server to said second server; and in performing said step of verifying said device signature said second program instructions further cause said second server to associate said primary device identifier with a copy of said device signature stored therein.

37. The system according to claim 36, wherein said step of verifying said device signature is performed with reference to said primary device identifier.

38. The system according to claim 35 wherein said first server transmits said device signature responsive to a control signal from said user device.

39. The system according to claim 35, wherein said first server generates said device signature independently of said user device.

40. The system according to claim 35, wherein said device signature is transmitted to said first server by said user device.

41. The system according to claim 35, wherein said first program instructions cause said first server to perform the steps of:
transmitting a device configuration parameter fingerprint of said user device to said second server; and
wherein responsive to receipt of said device configuration parameter fingerprint from said first server said second program instructions further cause said second server to further perform the step of:
verifying said device configuration parameter fingerprint.

42. The system according to claim 41, wherein said device configuration parameter fingerprint is encrypted.

43. The system according to claim 35, wherein said step of mutating said device signature comprises randomly varying a bit representation thereof.

44. The system according to claim 35, wherein said first server comprises a random timer, and said first server transmits said device signature responsive to a signal from said random timer.

45. The system according to claim 35, wherein said first program instructions cause said first server to perform the steps of:
transmitting a customer account signature of said user device to said second server; and
wherein responsive to receipt of said customer account signature from said first server said second program instructions further cause said second server to further perform the step of:
verifying said customer account signature;
mutating said customer account signature to define a mutated customer account signature; and
communicating said mutated customer account signature to said first server.

46. The system according to claim 45, wherein said first program instructions further cause said first server to perform the step of transmitting a username of a user of said user device to said second server; and
said second program instructions further cause said second server to associate said username with a copy of said customer account signature in said step of verifying said customer account signature.

47. The system according to claim 45, wherein said steps of transmitting said device signature and transmitting said customer account signature from said first server to said second server are performed as a response to a challenge of said second server that is issued to said first server via said data network.

48. The system according to claim 45, wherein said first program instructions further cause said first server to perform the step of:
encrypting said customer account signature using a password of a user of said user device.

49. The system according to claim 48, wherein said first program instructions further cause said first server to perform the step of transmitting said password to said second server.

50. The system according to claim 45, wherein said customer account signature is stored in said first server.

51. The system according to claim 45, wherein said customer account signature is stored in said user device.

52. The system according to claim 35, wherein said device signature is stored in said first server.

53. The system according to claim 35, wherein said device signature is stored in said user device.

54. A computer software product for authentication of a participant in an electronic transaction, comprising a computer-readable medium in which computer program instructions are stored, which instructions, when read by a computer, cause the computer to perform the steps of:
receiving a device signature of a device from a transmitter;
verifying said device signature;
mutating said device signature to define a mutated device signature; and
communicating said mutated device signature to said transmitter.

55. The computer software product according to claim 54, wherein said step of verifying said device signature is performed with reference to a primary device identifier that identifies said device.

56. The computer software product according to claim 54, wherein the computer further performs the steps of:
receiving a device configuration parameter fingerprint of said device; and
verifying said device configuration parameter fingerprint.

57. The computer software product according to claim 56, wherein said device configuration parameter fingerprint is encrypted.

58. The computer software product according to claim 54, wherein said step of mutating said device signature comprises randomly varying a bit representation thereof.

59. A computer software product for authentication of a participant in an electronic transaction, comprising a computer-readable medium in which computer program instructions are stored, which instructions, when read by a computer, cause the computer to perform the steps of:
receiving a device signature of a device from a transmitter;
receiving a customer account signature of said device from said transmitter;
verifying said device signature;
verifying said customer account signature;
mutating said device signature to define a mutated device signature;
mutating said customer account signature to define a mutated customer account signature; and
communicating said mutated device signature and said mutated customer account signature to said transmitter.

60. The computer software product according to claim 59, wherein said step of verifying said device signature is performed with reference to a primary device identifier that identifies said device.

61. The computer software product according to claim 59, wherein the computer further performs the steps of:
receiving a device configuration parameter fingerprint of said device; and
verifying said device configuration parameter fingerprint.

62. The computer software product according to claim 61, wherein said device configuration parameter fingerprint is encrypted.

63. The computer software product according to claim 59, wherein said step of mutating said device signature comprises randomly varying a bit representation thereof.

64. The computer software product according to claim 59, wherein said steps of receiving said device signature and receiving said customer account signature are performed as a response to a challenge issued to said transmitter.

65. The computer software product according to claim 59, wherein the computer further performs the step of encrypting said customer account signature using a password of a user of said device.

66. The computer software product according to claim 59, wherein the computer further performs the steps of:
receiving a password of a user of said device from said transmitter; and
verifying said password.

67. The computer software product according to claim 66, wherein said password is an encrypted password.

68. The computer software product according to claim 59, wherein the computer further performs the steps of:
receiving a username of a user of said device from said transmitter, wherein said step of verifying said customer account signature is performed with reference to said username.
